(19) United States
(12) Patent Application Publication
(10) Pub. No.: US 2010/0053474 A1
(43) Pub. Date: Mar. 4, 2010

(54) SYSTEMS AND METHODS FOR ELIMINATING LASER LIGHT SOURCE SCINTILLATION IN A PROJECTION TELEVISION

(76) Inventor: Hiromi Kamei, Irvine, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 12/544,937

(22) Filed: Aug. 20, 2009

Related U.S. Application Data
(60) Provisional application No. 61/093,321, filed on Aug. 31, 2008.

(51) Int. Cl. H04N 9/31; G03B 21/62; G02B 27/48; H04N 5/64

(52) U.S. Cl. 348/744; 359/457; 359/446; 353/121; 348/E09.025; 348/E05.128

(57) ABSTRACT

Systems and methods that facilitate the elimination of screen scintillation in a projection television having a laser light source. In a preferred embodiment, a display screen assembly of the television includes a liquid dispersed between the fresnel lens and lenticular screen, and sealed there between by a seal extending about the perimeter of the screen assembly. One or more vibration units are operably coupled to the liquid causes the liquid to vibrate between the Fresnel lens and lenticular screen as the light emanating from the laser light source diffuses through the liquid.

### CROSS-REFERENCE TO RELATED APPLICATION

This application claims the benefit of provisional application Ser. No. 61/093,321 filed Aug. 31, 2008, which is fully incorporated herein by reference.

### FIELD

The embodiments described herein relate generally to laser light source based projection televisions and, more particularly, to systems and methods that facilitate the elimination or reduction of laser light source scintillation on the display screen.

### BACKGROUND INFORMATION

Laser light source based projection televisions (PTVs) have a much larger color gamut than conventional projection televisions enabling images to be displayed using a greater range of colors resulting in images with brilliant colors. However, as with other systems using laser light, laser light source based PTVs can experience the occurrence of scintillation or speckling as the images are projected on to the screen.

The speckling that happens when an illuminating laser strikes a rough surface of the display screen can distract viewers and interfere with their enjoyment of a video from a laser-illuminated video projector. The speckles occur at points where the coherent light emerging from one point on the screen interferes with light emerging from another nearby point. The bright points in a speckle pattern are a function of the local heights of points on the screen and of the phase of the light waves.

In a video projector, one way to eliminate speckle is to continuously change the path length that the coherent light takes, in effect continuously changing the phase of the light striking the screen. Then the bright spots in the speckle pattern disappear and reappear somewhere else continuously. Strictly speaking, the screen is still speckling. But the speckle pattern is changing between frames and in the end, the viewer's eye integrates the speckles of individual frames into a continuous level of color.

Thus, systems and method that eliminate the viewer's recognition or awareness of screen speckling due to scintillation are desirable.

### SUMMARY

The embodiments provided herein are directed to systems and method that eliminate or significantly reduce a viewer's recognition or awareness of screen speckling due to scintillation. In one embodiment, a television includes a video display screen mounted on an enclosure and a laser light source, an image display engine, and optics including mirrors and lenses optically coupled to the display screen. The display screen includes a Fresnel lens coupled in spaced relation to a lenticular screen. Filling the space between the Fresnel lens and lenticular screen is a liquid. A seal extends around the edges of the Fresnel lens and lenticular screen to retain the liquid in the space. A mechanism to cause the liquid to vibrate is couple along one or more edges of the Fresnel lens and lenticular screen. The mechanism may include an ultra sound generating device, ultrasonic wave device, an oscillating or vibrating device, and the like. By vibrating the liquid between the Fresnel lens and lenticular screen, the path length that the coherent light emanating from the laser light source takes as it diffuses through the liquid is caused to continuously change. The refracting laser light and the changing light reverberate within the liquid resulting in the light beam saturating evenly within the vibrating liquid as the light beam is projected onto the lenticular screen.

Other objects, systems, methods, features, and advantages of the invention will be or will become apparent to one with skill in the art upon examination of the following figures and detailed description. It is intended that all such additional systems, methods, features and advantages be included within this description, be within the scope of this invention, and be protected by the accompanying claims. It will be understood that the particular methods and apparatus are shown by way of illustration only and not as limitations. As will be understood by those skilled in the art, the principles and features explained herein may be employed in various and numerous embodiments.

### BRIEF DESCRIPTION OF THE FIGURES

The details of the example embodiments, including fabrication, structure and operation, may be gleaned in part by study of the accompanying figures, in which like reference numerals refer to like parts. The components in the figures are not necessarily to scale, emphasis instead being placed upon illustrating the principles of the example embodiments. Moreover, all illustrations are intended to convey concepts, where relative sizes, shapes and other detailed attributes may be illustrated schematically rather than literally or precisely.

FIG. 1 is a side view schematic of a projection television (PTV) with a laser light source.

FIG. 2 is a partial perspective view schematic of the screen of the PTV in FIG. 1.

FIG. 3 is a schematic of a television system.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to produce systems and methods that eliminate or significantly reduce a viewer's recognition or awareness of screen speckling due to scintillation. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detail description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

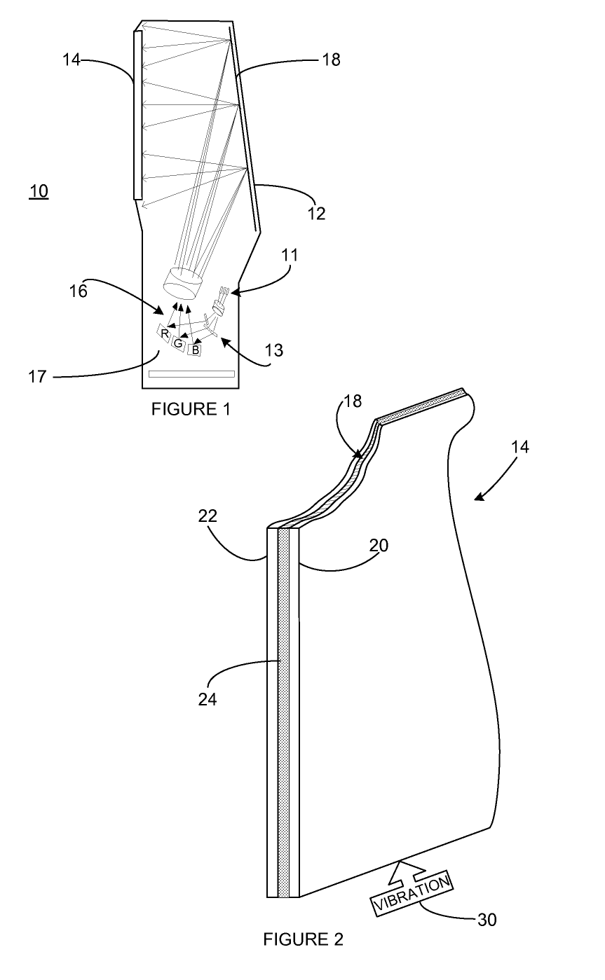

Turning in detail to the figures, FIG. 1 depicts a schematic of a projection television (PTV) 10 having a laser light source. The PTV 10 comprises a cabinet or enclosure 12, an image display engine or system 13, e.g., a DLP, LCD or LCOS based projection engine or the like, optics such as mirrors 16 coupled to the image engine 13, a laser light source 11 coupled to the image engine 13, a projection screen assembly 14 attached to the front of the cabinet 12, and a mirror 18 mounted in the interior 17 of the cabinet 12 and optically coupled to the projection screen assembly 14 and the image projection engine 13 and optics 16. Also mounted in the interior 17 of the cabinet 12 is a chassis 15 comprising logic circuits and other electronic components.

As depicted in FIG. 2, the display screen assembly 14 of the PTV 10 includes includes a Fresnel lens 20 interiorly coupled in spaced relation to a lenticular screen 22. The screen assembly 14 preferably includes a liquid 18, such as, e.g., an ethylene glycol type liquid, an ion liquid, or the like, dispersed between the lenticular screen 22 and the fresnel lens 20. A seal 24 extends about the perimeter of the Fresnel lens 20 and lenticular screen 22 to seal the liquid 18 there between. A vibration system 30 comprising one or more vibration generating devices operably coupled to the liquid 18 and coupled to the Fresnel lens 20 and lenticular screen 22 along one or more edges of the screen assembly 14. The vibration generating devices can include an ultrasonic wave device, an ultrasound generating device, an oscillator, an oscillating membrane, and the like.

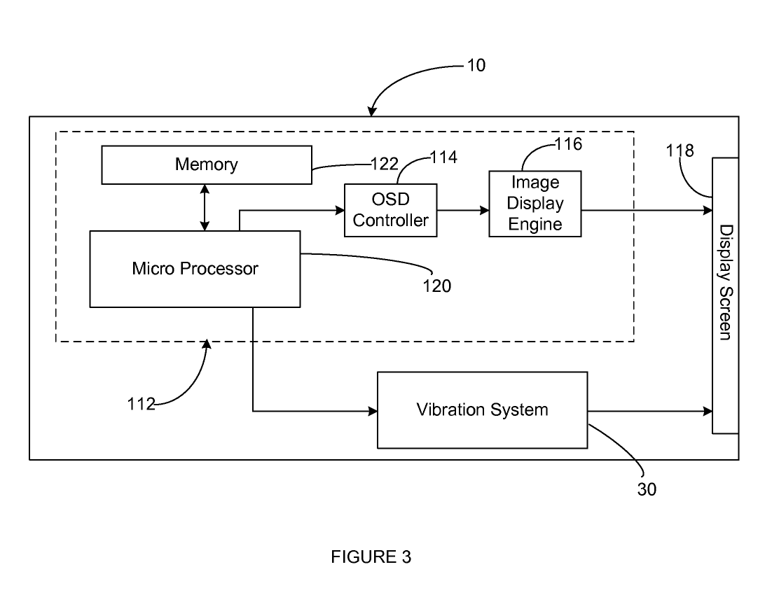

As depicted in FIG. 3, the vibration system 30 is shown coupled to the display screen 118 and microprocessor 120 of the control system 112 of the television 10. the microprocessor 120 controls the operation of the vibration system 30. The control system 112 preferably includes non-volatile memory 122 upon which system software is stored, an on screen display (OSD) controller 114 coupled to the micro processor 120, and an image display engine 116 coupled to the OSD controller 114 and the display screen 118. The system software preferably comprises a set of instructions that are executable on the micro processor 120 to enable the setup, operation and control of the television 10.

In operation, the vibration, motion or wave generating system 30 will cause the liquid 18 or the molecules of the liquid between the Fresnel lens 20 and lenticular screen 22 to vibrate or move as the light which forms the projected image passes from the Fresnel lens 20 diffuses through the liquid 18 to the lenticular screen 22. By vibrating the liquid 18 between the Fresnel lens 20 and lenticular screen 22, the path length that the coherent light from the laser light source 11 takes as it diffuses through the liquid 18 is caused to continuously change, in effect, continuously changing the phase of the light striking the lenticular screen 22, which tends to eliminate for the viewer the appearance of light speckling due to scintillation on the screen 22. The refracting laser light and the changing light reverberate within the liquid resulting in the light beam saturating evenly within the vibrating liquid as the light beam is projected onto the lenticular screen.

In the foregoing specification, specific example embodiments have been described. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

What is claimed is:

1. A television comprising
an enclosure,
a video display screen mounted on the enclosure, the display screen includes a Fresnel lens coupled in spaced relation to a lenticular screen with the space between the Fresnel lens and lenticular screen filled with a liquid,
a laser light source optically coupled to the display screen, and
a vibration source operably coupled to the liquid to cause the liquid to vibrate.

2. The television of claim 1 further comprising a seal extending about the perimeter of the screen.

3. The television of claim 1 wherein the vibration source comprising one or more vibration generating devices coupled to one or more sides of the screen.

4. The television of claim 3 wherein the one or more vibration generating devices comprises an ultrasound generating device.

5. The television of claim 3 wherein the one or more vibration generating devices comprises an oscillator.

6. The television of claim 3 wherein the one or more vibration generating devices comprises an oscillating membrane.

7. A television comprising
an enclosure,
a display screen assembly comprising a Fresnel lens coupled in spaced relation to a lenticular screen and mounted on the enclosure,
a liquid disposed in the space between the Fresnel lens and lenticular screen,
a laser light source optically coupled to the display screen, and
a motion generation source operably coupled to the liquid to cause the molecules of the liquid to move.

8. The television of claim 7 further comprising a seal extending about the perimeter of the screen.

9. The television of claim 7 wherein the liquid is glycol.

10. A method of reducing screen scintillation in a laser light source television comprising the steps of
diffusing the light which forms a projected image through liquid as it passes from a Fresnel lens to a lenticular screen, and
continuously changing the phase of the light striking the lenticular.

11. The method of claim 10 wherein in the step of continuously changing the phase of the light striking the lenticular screen includes continuously altering the length of the path that the coherent light from the laser light source takes as it diffuses through the liquid.

12. The method of claim 10 wherein the length of the path that the coherent light from the laser light source takes is altered by vibrating the liquid between the Fresnel lens and the lenticular screen.

13. A method of reducing screen scintillation in a laser light source television comprising the steps of
projecting an image onto a display screen assembly of the television, wherein the display screen assembly comprising a Fresnel lens coupled in spaced relation to a lenticular screen with a liquid filling the space formed there between; and
causing the molecules of the liquid to move as the light of the projected image diffuses from the Fresnel lens through the liquid to the lenticular screen.
